(19) United States
(12) Patent Application Publication
(10) Pub. No.: US 2012/0073195 A1
(43) Pub. Date: Mar. 29, 2012

(54) PLANT GROWTH AND GARDEN BAGS AND METHOD OF CULTIVATING PLANTS THEREIN

(76) Inventor: Acharmu Crosby, Wheeler, OR (US)

(21) Appl. No.: 13/221,660

(22) Filed: Aug. 30, 2011

Related U.S. Application Data
(60) Provisional application No. 61/378,852, filed on Aug. 31, 2010.

(51) Int. Cl. A01G 9/02

(52) U.S. Cl. 47/66.7

(57) ABSTRACT

A plant growth bag has a substantially square cross section and is made from needle-punched, spunbond, non-woven polypropylene. A plant grows in growth media contained by the bag. In one aspect, the bag is placed into a basin that holds water that drains from the bag. Roots grow through the bag. In another aspect, the bag is placed in a second, larger bag also containing growth media, and the roots grow through the second bag and into water accumulated in the basin.

### RELATED APPLICATION

This application claims priority from U.S. Provisional Application No. 61/378,852 filed Aug. 31, 2010, which is incorporated herein by reference for all purposes.

### BACKGROUND

A plant growth and garden bag and method of cultivating plants therein is provided. The plant growth bags have an open top, and a bottom. The plant growth bags are essentially square in shape and are made from needle-punched, spunbond, non-woven polypropylene. The fabric permits water, nutrient solution and environmental air to permeate the plant growth bags, thus permitting plant roots to receive essential elements through the plant growth bag.

Once the plant roots grow through the walls of the plant growth bag, the entire bag can then be inserted into a larger bag pre-filled with growing media, or provided with water and nutrient solution in a larger trough, reservoir or other shallow basin, or both.

The plant growth bag and method provides for the cultivation of plants through stages of sowing, seedling, root formation after cloning, or long-term growth of the same. The plant growth bags are graduated so that the primary root ball and the secondary roots are encouraged to grow through layers of media and plant growth bags. This effectively eliminates the process of extraction-type transplanting.

Gardening often requires a trough, basin or reservoir to catch run-off drainage following watering. The run-off, or effluent, is generally either actively recirculated throughout the closed system, or discarded as a waste product.

The present invention provides for a method of utilizing the totality of the irrigation applied, effectively establishing and maintaining a zero-waste gardening or farming environment.

The present invention provides the gardener or farmer with the options of;

1) Encouraging root development outside of the plant growth bags, into an external basin, trough or shallow reservoir of run-off nutrient solution, water, or a mixture thereof; the run-off being accumulated or applied by either top-feeding, sub-irrigation, or both;

2) Successively placing smaller plant growth bags into larger plant growth bags pre-filled with growing media, and providing the roots of the plant with increased volume of media to grow. Roots are able to grow through several layers of plant growth bags and growing media without physical restriction. The present invention provides a device and process which reduce root shock and damage often caused by traditional transplanting practices, effectively eliminating the process of extracting a plants' root mass and structure from a smaller container and placing the same into a larger container, commonly referred to and referenced herein as “transplanting”;

3) Providing a shallow basin, trough or reservoir of water and, or nutrient solution for the plants' roots to grow into once the plants' roots grow through and extend from the plant growth bag. This method allows the gardener or farmer to supply direct nutrient solution and water to the plants' roots, without providing additional growing media for the plants' roots.

1. Field of Invention

The present invention generally relates to plant growth bags and methods of cultivating plants therein.

2. Description of the Prior Art

Gardening and farming generally seek to optimize efficient usage of available space to produce the maximum foliage, fruit, flowers and roots during a given cycle or season. Containers for gardening and farming are predominantly made of rigid plastic, forming solid walls of the container.

Recently, hobby, horticultural and commercial gardeners and farmers have used fabric containers to grow plants and trees in.

Fabric containers described in the prior art have implemented design features that seek to restrict root growth to the inside of the fabric container, by “air pruning” the plants' root tips at the point where the root tips come into contact with the restrictive walls of the fabric container.

Methods of growing plants in fabric containers are disclosed in U.S. Pat. No. 4,574,522, issued to Reiger, Whitcomb, PhD., on Mar. 11, 1986, U.S. Pat. No. 5,768,825, issued to Reiger on Jun. 23, 1998, and U.S. Pat. No. 7,481,025, issued to Whitcomb, PhD., on May 28, 2003.

Materials and methods described in the aforementioned prior art disclosures may be useful and successful in growing plants and restricting root growth to inside of the fabric container by “air pruning” plants' roots. The present invention discloses materials and methods that promote and encourage plant roots' elongation and non-restrictive growth through the walls of and outside of the fabric container. Thus, the present invention presents materials, methods and design features that substantially differ from the design goals and functionality of the prior art.

The present invention discloses methods that prevents root shock or damage that can be caused by transplanting from a smaller container to a larger container during the growing cycle of the plant or tree. Traditional and common practices of transplanting involve the physical extraction of the plants' root mass, and entire plant structure, from a given container, which is then placed into a larger container, once roots have colonized and outgrown the smaller, initial container. This common practice of transplanting may result in shock or stunting to the plants' roots during the physical extraction process. Common transplanting practices may also result in physical damage to the root structure, or loss of root mass due to the plant roots' establishment in the growing media, or handling of roots by the gardener or farmer.

The present invention effectively eliminates the practice of extraction of the root mass from the fabric container, as the roots are free to grow through the fabric container. Once the roots grow through the fabric container, the gardener or farmer may then simply place the entire smaller fabric container into a larger fabric container, partially pre-filled with growing media. The smaller fabric container is then fully covered by growing media. The plants' roots continue to grow through the walls of the interior plant growth bag, into the surrounding media, and further through sequentially larger plant growth bag walls.

This application discloses a fabric plant container composed of permeable material specifically selected to facilitate the growth and expansion of plant and tree roots through apertures in the material.

The apertures are formed by the needle-punch manufacture of the spunbond polypropylene. The apertures permit gas exchange to occur between the interior of the plant growth bag and the environmental air, or oxygen. Plant roots seek oxygen, and are able to affix this oxygen, while simultaneously uptaking water and nutrient solution held in the external trough, tray, basin, or reservoir.

The plant bags referenced in the U.S. patents, aforementioned, are manufactured in a circular or cylindrical shape. The present plant bag is manufactured with a square or cubical shape. The shape of the fabric container facilitates holding a greater volume of growing media. For example, a cylindrical fabric plant container, having a height of 12 inches (30.5 cm) and a base of 12 inches (30.5 cm), has a maximum holding capacity of 1357 cubic inches (3447 cubic cm.) of growing media and plan roots. A square to cubical shaped fabric plant container has a maximum holding capacity of 1728 cubic inches (4390 cu.cm.). The present application discloses a fabric plant bag which maximizes efficiency by providing a physical structure which has a greater volume of holding capacity for growing media and roots than prior art bags.

The prior art bags were designed to maintain plants and trees in a nursery, or in the field, pending transport, further cultivation, or sale of the plant or tree as a product prepared for further cultivation. The present invention is designed to maximize root growth, without physical restrictions built into the fabric container that would restrict root growth. The prior art utilizes a material that does not feature apertures, or small needle-punched holes, for the permeation of water and oxygen. The material selected by the prior art has a heavier weight, and thicker profile, that essentially snag roots in the cross-weaved fibers. The prior art material is designed to entangle roots until the roots “air prune”, or, are deprived of a free channel to grow through, thus dying off primarily due to asphyxiation.

The present invention is specifically designed to be physically efficient by utilizing a square to cubical shape. This disclosure is designed to permit gases and liquids, required by the plant or tree for survival, to be freely exchanged with the environment, including, but not limited to cation exchange and oxygen and CO₂ assimilation, through the permeable walls and bottom of the material of the present plant bag.

Thus, there is a need for an improved method of cultivating plants and trees in flexible, permeable, fabric containers that are designed specifically for root growth, expansion and mass accumulation through the fabric bags.

### SUMMARY OF THE INVENTION

The present invention provides a novel fabric plant growth bag and methods of cultivating plants and trees therein whereby plant roots are encouraged to grow through the bottom and walls of the plant bag, and further eliminates extraction transplanting by placing smaller plant growth bags into larger plant growth bags, thus meeting the goals of maximizing root growth and eliminating transplanting.

The plant growth bags of the present invention promote and encourage plant and tree root growth through the bottom and walls of the selected fabric. The entire smaller plant growth bag is then placed into a larger plant growth bag containing sufficient growing media when roots reach desired mass on the exterior of the plant growth bag. Gardeners and farmers skilled in the art and novice hobbyists will benefit from the elimination of the process of extracting the root mass from a solid, rigid walled container to transplant the crop into a larger container. Instead, the entire plant growth bag is placed into a larger bag, reducing to totally eliminating root shock or damage caused by handling of delicate plant roots.

The plant growth bags are essentially square in cross section and may have a cubical in shape. They are formed by vertical and lateral seams equidistant from each other, which form four corners on the top and bottom of the plant growth bag.

Roots grow through the medium on the interior of the plant growth bag and through the small apertures or needle-punched holes of the specifically selected fabric. Once plant roots have established structures on the exterior of the plant growth bag, the entire plant growth bag may be placed into a larger plant growth bag pre-filled with growing media, or, alternatively, supply a source of moisture in the form of nutrient solution held in a shallow reservoir in an external basin, trough, tray, or other low-walled vessel. The preferred low walls of the external vessel permit environmental air or oxygen or CO₂ to freely flow through the walls of the plant growth bag, thereby providing essential elements to the plant or tree.

The present invention substantially reduces the labor, and technical skills normally required to transplant a plant into a larger container. The present invention reduces to eliminates the potential for root damage caused by extracting the root mass from a traditional solid-walled nursery or other plant-holding container when a plant is transplanted.

The present invention promotes and encourages unrestricted root growth, with the desired goal of accumulating the largest root mass possible both within the plant growth bag and on the exterior of the plant growth bag, for example, into and in an external reservoir of water or nutrient solution.

The present invention specifically incorporates design features that promote water conservation and general gardening and farming efficiency. The plant growth bags herein disclosed provide a visual gauge to the gardener or farmer for the calculation of water uptake by the plant, and thus gives an exact indication of how much water or nutrient solution is required by the plant. This promotes efficient application of water and nutrient resources. The plant is fed water or nutrient solution by pouring, dripping, or trickling water onto the top of the growing media. The run-off, or effluent travels through the growing medium, and drains into a shallow basin. The plant growth bag permits plant roots to grow from within the interior of the container to the exterior of the plant growth bag.

### BRIEF DESCRIPTION OF THE DRAWINGS

FIG. 1 is a perspective view of a plant growth bag and attached handle with a plant within the interior of the plant growth bag and with plant roots growing through the walls and bottom of the bag.

FIG. 2. is a perspective view of a plant growth bag with a plant within the interior of the same plant growth bag and plant roots growing from within the interior to the exterior and further into a shallow reservoir of nutrient solution.

FIG. 3. is a cross-sectional view of a plant growth bag having a plant within its interior and with plant roots growing through the walls and bottom and further into a shallow reservoir of nutrient solution.

FIG. 4. is a perspective view of a smaller size plant growth bag within a larger size according to the present invention.

FIG. 5. is a perspective view of a smaller size fabric plant growth bag within a larger size fabric plant growth bag with a plant within the smaller bag and plant roots growing through the side walls and bottom of both plant bags into a basin holding a shallow level of nutrient solution.

FIG. 6. is a cross-sectional view of the bags and plant shown in FIG. 5.

FIG. 7. is a perspective view of a smaller size plant growth bag with a plant on the interior thereof covered by growing media inside of a larger plant growth bag on the top of a generic lattice riser and roots growing into a shallow solid tray holding a water soluble nutrient solution.

FIG. 8. is a cross-sectional view of the bags and plant shown in FIG. 7.

FIG. 9. is a perspective view of a smaller size plant growth bag within the interior of a larger size plant growth bag planted in the earth with roots growing through the walls and the bottoms of the smaller and larger size plant growth bags into the earth.

FIG. 10. is a cross-sectional view of the bags and plant shown in FIG. 9.

### DESCRIPTION OF THE PREFERRED EMBODIMENTS

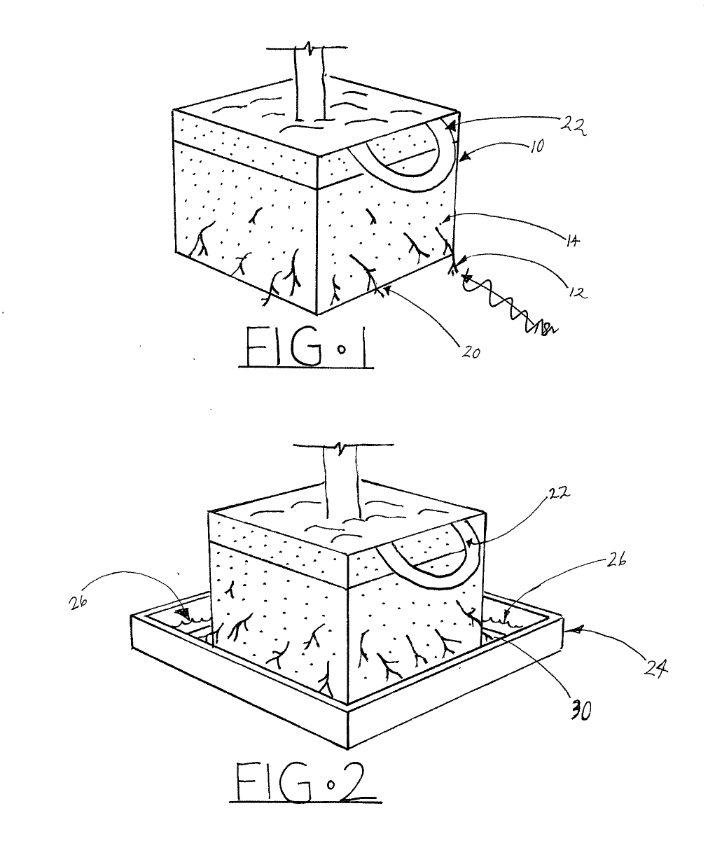

Referring now to the drawings, specifically FIG. 1, a plant is shown within a fabric container 10 having its roots 12 growing from within the interior through 1 mm apertures 14 in the fabric to the exterior 16 of bag 10. The roots 12 are illustrated extending unrestricted from within bag 10 to the exterior walls and bottom 20 of bag 10 and through the needle-punched holes 14 in the bag. Also illustrated is a handle 22 attached to the bag for lifting and examining the plant and plant roots.

FIG. 2. illustrates a plant growth bag with a plant therein placed inside of a shallow trough, tray, basin or reservoir 24. The plant is top-fed water or nutrient solution until run-off 26, or effluent is accumulated to a shallow level in the trough 28. Roots of the plant grow through the walls and bottom into the run-off 30 and continue to grow in the same run-off, unrestricted and un-pruned by the plant growth bag of the present invention.

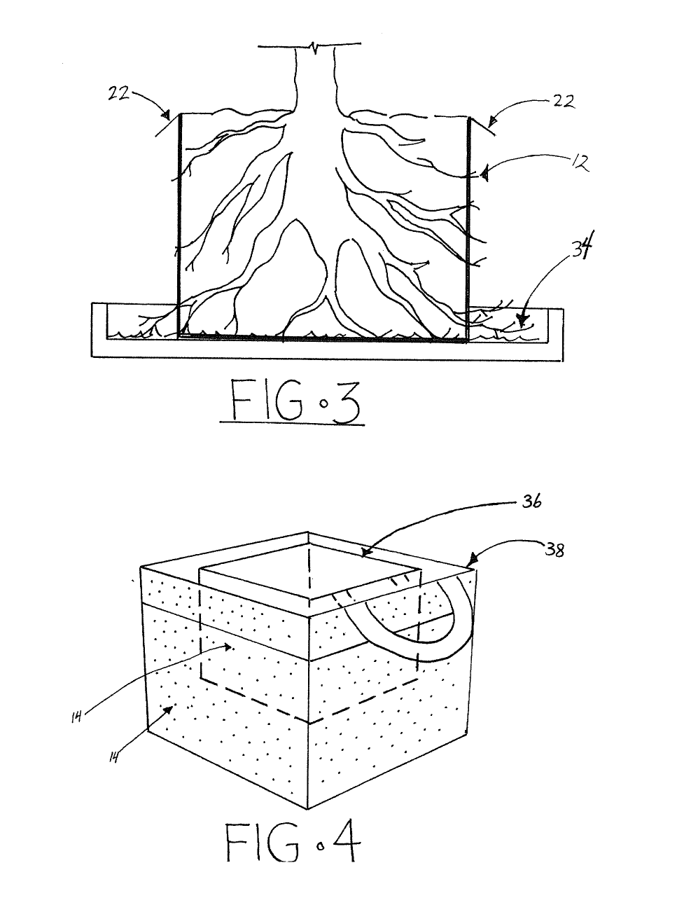

FIG. 3 is a cross-sectional view of the plant bag with a plant therein. The plants' roots 12 grow through the side walls 32 of the bag into environmental air, and other plant roots grow through the bottom 34 of the plant growth bag into the shallow basin of nutrient solution.

FIG. 4 illustrates a smaller size plant growth bag 36 within the interior of a larger size plant bag 38.

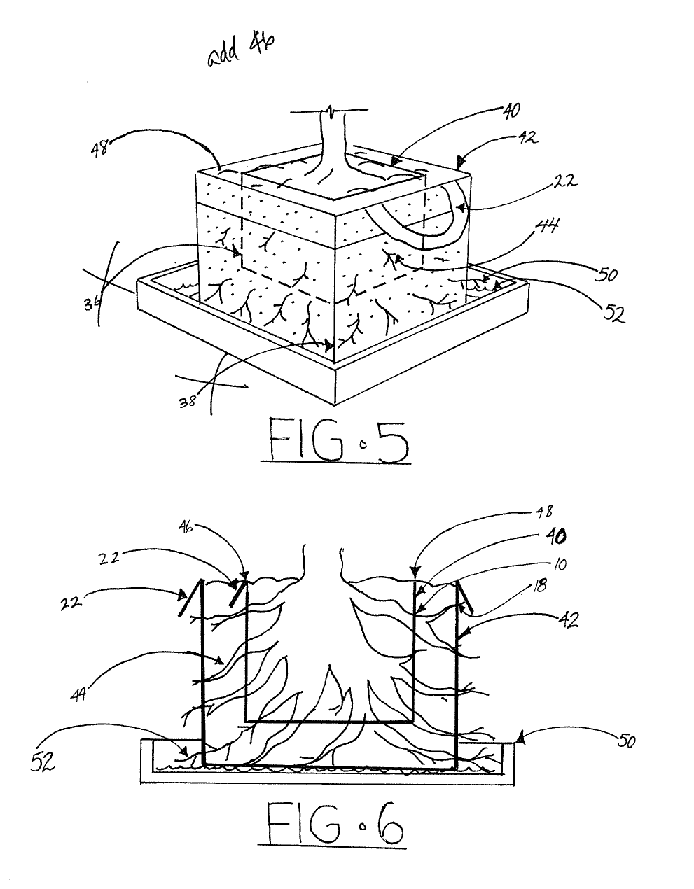

FIG. 5 illustrates a smaller size plant growth bag 40 with a plant therein, within the interior of a larger plant growth bag 42. The smaller bag is placed within the larger following sufficient root growth and root establishment on the exterior walls of the smaller plant growth bag. Once roots have accumulated sufficient mass on the exterior of the smaller size of the bag 40, the entire plant growth bag and root mass on the exterior thereof is placed into a larger size plant growth bag, pre-filled with growing media 46. The smaller size plant growth bag is then covered with growing media 48. This process substantially eliminates any damage to or loss of the accumulated root mass of the plant that may be caused by extraction type transplanting. Instead, the practice of extracting a root mass from within a container for the purpose of placing the large root mass of a plant into a larger container, is eliminated. A smaller size of the bag 40 is simply placed into a larger size of bag 42, thereby decreasing root shock or root damage that may be caused by handling during traditional transplanting practices. This improvement on the prior art substantially reduces labor and technical skills required to transplant plants from smaller to larger containers. This improvement on the prior art also sustains the accumulated root mass of the plant, thereby reducing injury and physical stress upon the plant and the plants' roots, resulting in a cumulatively larger and healthier root mass than a plant whose roots have been pruned or damaged by processes described in the prior art as root pruning or transplanting and traditional practices of extraction type transplanting. Plant roots grow through the plant growth bags into a shallow basin 50 containing water or nutrient solution 52.

FIG. 6 illustrates a cross-sectional view of a FIG. 5. Once roots have accumulated sufficient mass on the exterior of the smaller size of the bag 40, the entire plant growth bag and root mass is placed into a larger size plant growth bag 42, pre-filled with growing media 46. The smaller size plant growth bag is then covered with growing media 48. Plant roots grow through the plant growth bags into a shallow basin 50 containing water or nutrient solution 52. Zero waste of water or nutrient solution accrue over the life of the plant or tree. The plant is irrigated once per 24 hours. The amount of water or nutrient solution provided can be equivalent to the amount of water or nutrient solution the plant uptakes during the 24 hour period. Specifically, those skilled in the art may select to provides nutrient solution until run-off, or effluent, accumulates to precisely ⅛ inch to 1 inch (0.32 cm to 2.54 cm), depending on the size of the plant or tree's root mass. Generally, water is applied only until run-off. The plant growth bag will continue to drain moisture through the growing media and out of the plant growth bag. The resulting run-off that is accumulated in the external basin, if used, will be a low enough level that the plant or trees roots will grow through the plant growth bag of the present invention, and uptake water. The purpose of providing water only until run-off begins is to maximize efficiency by replenishing nutrient solution and water to the plant and by top-feeding only when the shallow basin of run-off has depleted to a damp to dry level. This method effectively provides only what the amount of water that the plant or tree is actually up-taking and transpiring during a given period, specifically 24-36 hours, over which time an average plant or tree will uptake by capillary action and other plant physiology, given the proper environment, the water or nutrient solution held in an external basin, through the permeable walls and bottom of the selected fabric of the present invention.

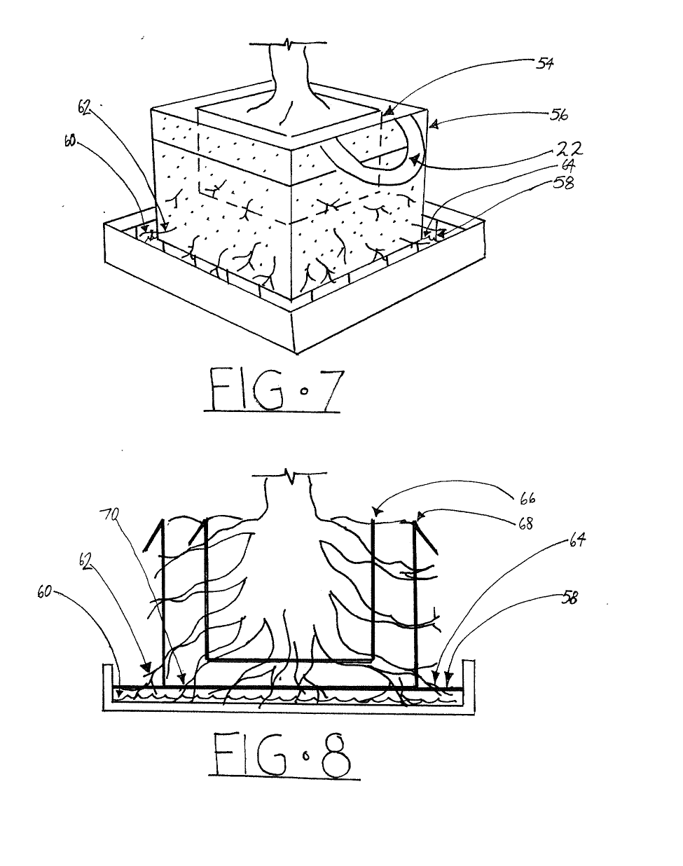

FIG. 7 illustrates a variation of usage of the present invention, whereby a smaller size plant growth bag 54 is within the interior of a larger plant growth bag 56 of the present invention, with the larger plant growth bag sitting atop a raised lattice platform 58. This variation creates an air gap 60 between the bottom of the plant growth bag and the water or nutrient solution held within the external basin. Plant roots grow through the plant root bags 54, 56 and down into the basin of water or nutrient solution 64. The air gap is to facilitate visual inspection of the mass accumulation of plant roots and to provide plant roots with oxygen held in general environmental air while root tips submerge into the shallow basin of water or nutrient solution.

FIG. 8 illustrates a cross section of a smaller plant growth bag 66 inside of a larger plant growth bag 68 with plant therein which is sitting atop a lattice or other generic riser. Plant roots grow through both the smaller and larger sizes of the plant growth bags, through the lattice, remain suspended in the air gap, and root tips submerge and continue to grow and expand in the water or nutrient solution held within an external reservoir 70.

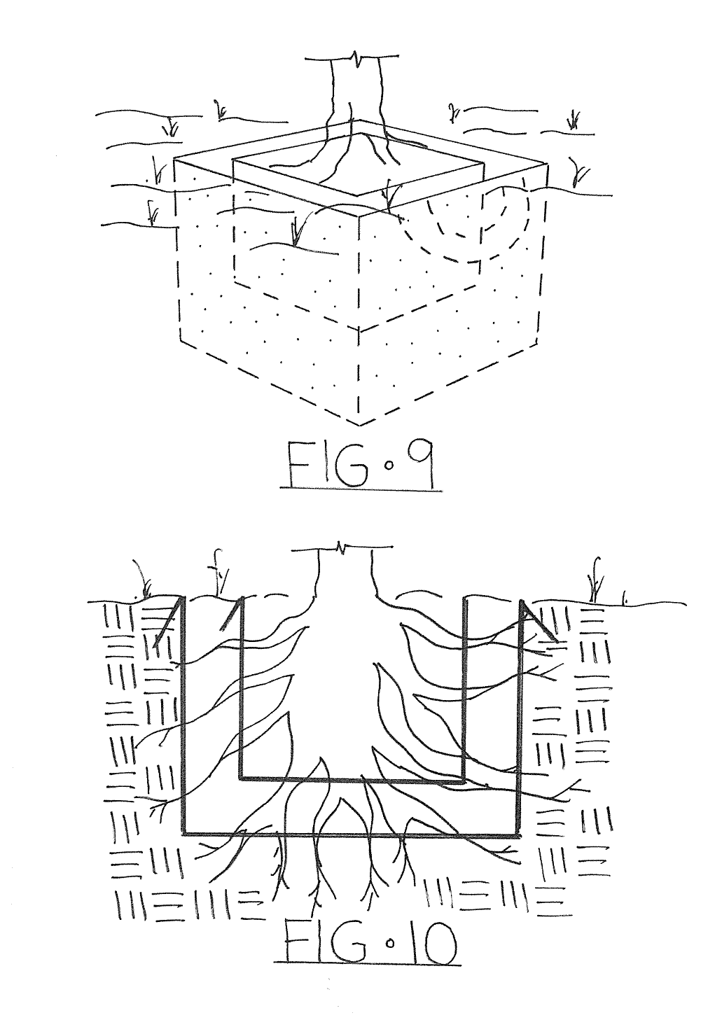

FIG. 9 illustrates a smaller plant growth bag 76 and a larger plant growth bag 78 of the present invention with a plant therein placed into earth 72 outside. The plant's roots are able to grow through both walls and bottoms of the plant growth bags and continue unrestricted growth into the surrounding natural earth, open field, or other bed or larger plant growth bag.

FIG. 10 illustrates a cross section of a smaller plant growth bag 76 within a larger plant growth bag 78 sown into the natural earth 72, open field, or larger plant growth bag. Plant roots are able to grow unrestricted through the walls and bottoms of the bag into the growing media, or substrate, or natural earth surrounding the present bag.

The present invention is designed to simplify gardening and farming. The present invention is designed to conserve water. The present invention is designed to maximize resources and efficiency in the garden or farm.

### Simplicity

The general usage of the present invention is designed to be simple. A gardener or farmer begins a seedling, scion, or cutting in a smaller plant growth bag, 1 liter being the ideal starting size. The plant growth bag is optionally placed into a low-walled, trough, tray, basin, or other container whose dimensions are slightly larger than the given plant growth bag. The trough is ideally composed of low walls for the purpose of permitting environmental gases such as oxygen and c02 to be exchanged through the permeable apertures, or holes in the selected fabric according to the present invention. The plant is fed a water soluble nutrient solution until run-off trickles out of the plant growth bag and accumulates into a shallow level in the external trough or generic reservoir. The top-feeding is stopped when the run-off accumulates to a level only slightly submerging the plant growth bag. The plants' roots are permitted to freely grow unrestricted through the apertures and thin composition of the selected fabric into the shallow nutrient solution and out of the side walls into air, to assimilate oxygen or other gases the plant desires. When top-fed only one time per day, the plant uptakes water from below, generally up-taking the shallow accumulation of run-off within a 24 hour period. Thus, the gardener or farmer need only feed, or water the plant or tree once per day, due to the ability of plant roots to grow through the bag and further uptake run-off water from the external basin or reservoir. Thus, this method of watering a plant once per day greatly simplifies the process of gardening and farming.

### Water Conservation

The present invention is designed to conserve water. The practice of watering plants varies greatly depending on the specific crop and methods used to cultivate the specific crop. When the plant bag is utilized as recommended, the gardener or farmer will be able to apply only the amount of water the plant requires. The gardener or farmer simply examines the level of water or nutrient solution held in the external basin and top-feeds to maintain the level. The plant uptakes water from the nutrient solution held in the basin below at a given rate. The gardener or farmer simply pours, drips, or trickles water onto the top of the media in the plant growth bag when the water level below decreases or the basin becomes damp to dry. No water or nutrient solution is ever wasted. The entirety of the top-applied water or nutrient solution is used by the plant due to the plants' roots ability to grow through the bag and uptake water from an external water source, which can be held in any basin. Thus, the present invention, when implemented in accordance with the methods described herein, conserves water and nutrient solution, and further culminates in net zero waste of water and/or nutrient solution. Every drop of water or nutrient solution that is applied from the top drains through the growing medium and the plant growth bags, and into an external basin or trough, to which roots have unrestricted access. Plant roots are free to uptake water at the rate which satisfies their needs without need for additional top-fed water. The gardener visually examines the amount of water up-taken by the plant, and applies additional water only when the level is depleted to a damp to dry state.

### Maximizing Efficiency

The plant growth of the present invention maximizes efficiency in the garden or on the farm. Traditional extraction type transplanting is totally eliminated, reducing labor costs, and potential damage or injury to plants' roots caused by handling during transplanting. Instead, an entire plant growth bag is planed inside of a larger plant growth bag, and plant roots are able to grow through the permeable walls of the fabric container, which is covered by small apertures or needle-punched holes. The present invention maximizes efficiency by permitting the gardener, farmer, those skilled in the art, or novices to inspect and examine the root formation on the exterior of the plant growth bag and the approximate to exact uptake of water or nutrient solution from a given external basin or reservoir. This eliminates guessing about how much water a given plant or tree uses during a given period. The gardener or farmer simply applies water by top-feeding when the level in the external basin becomes depleted. The simplest method is to apply water once per day, stopping top-application when the external water level only slightly submerges the bottom of the plant growth bag. After a 24 hour period, the water level is examined, and when that level decreases below the bottom of the plant growth bag, additional water is applied from the top. As a result, no water or nutrient solution is ever over-applied, nor wasted.

### No Air Pruning

The present approach does not air prune roots. The prior art emphasizes that air pruning is a desirable feature. The present approach is designed to maximize root growth and root mass, not damage, cull, or break off roots during any stage of the growing process. The process of air pruning roots by entanglement in a selected fabric is not viewed as an advantageous design feature, and thus is avoided according to the present invention. Instead, plant roots are encouraged to grow through the apertures or small holes in the selected fabric.

The selected fabric is a non-woven polypropylene, composed of a weight light enough to facilitate penetration and growth of roots through the material, and also needle-punched to further permit roots to grow through said holes into air and water supplied outside of the plant growth bag. The selected fabric is permeable, does not have a cross woven composition, and substantially permits root growth through several layers of growing media and sequential walls and bottoms of larger plant growth bags.

Thus, the present invention is well suited to eliminate extraction type transplanting, eliminate waste of water or nutrient solution, and to maximize efficient use of resources by the experimental station, gardener, farmer, those skilled in the art, or the hobbyist or novice.

The present invention embodies technical advantages and scalability as presented herein, and possesses inherent physical properties that offer further advantages to those skilled in the art and novices alike.

1. A method of growing a plant comprising:
placing a medium that supports root growth of the plant into a first bag made of a mesh fabric through which roots of the plant can grow;
initiating plant growth in the first bag;
growing the plant in the first bag; and
thereafter placing the first bag into a second bag containing a medium that supports root growth of the plant.

2. The method of claim 1 wherein the second bag is made of a mesh fabric through which roots of the plant can grow.

3. The method of claim 1 wherein the second bag is larger than the first bag.

4. The method of claim 1 wherein the first bag has a vertical axis and four substantially rectangular sides forming a substantially square shape when viewed in cross section orthogonal to the vertical axis.

5. The method of claim 1 wherein placing the first bag into a second bag containing a medium that supports root growth of the plant comprises placing the first bag into the second bag when plant roots begin to emerge from the first bag.

6. The method of claim 1 further comprising:
growing the plant in the second bag; and
thereafter placing the second bag into a third bag containing a medium that supports root growth of the plant.

7. The method of claim 6 wherein placing the second bag into a third bag containing a medium that supports root growth of the plant comprises placing the second bag into the third bag when plant roots begin to emerge from the first bag.

8. The method of claim 1 further comprising watering the plant while growing the plant in the first bag.

9. The method of claim 8 wherein watering the plant comprises:
setting the first bag on a relatively flat surface; and
putting water into the first bag from the top thereof.

10. The method of claim 9 further comprising:
permitting water to flow out of the first bag and onto the relatively flat surface; and
draining substantially all of the water flowing out of the first bag away therefrom.

11. The method of claim 8 wherein watering the plant comprises:
setting the first bag into a basin; and
putting water into the first bag from the top thereof.

12. The method of claim 11 further comprising:
permitting the water to flow out of the first bag and into the basin; and
collecting water in the basin to a predefined level on the first bag.

13. The method of claim 1 further comprising watering the plant while growing the plant in the second bag.

14. The method of claim 13 wherein watering the plant comprises:
setting the second bag on a relatively flat surface; and
putting water on a top surface of the growth medium.

15. The method of claim 14 further comprising:
permitting water to flow out of the second bag and onto the relatively flat surface; and
draining substantially all of the water flowing out of the second bag away therefrom.

16. The method of claim 13 wherein watering the plant comprises:
setting the second bag into a basin; and
putting water on a top surface of the growth medium.

17. The method of claim 16 further comprising:
permitting the water to flow out of the second bag and into the basin; and
collecting water in the basin to a predetermined level on the second bag.

18. A method for growing a plant comprising:
placing a medium that supports root growth of the plant into a bag made of a mesh fabric through which roots of the plant can grow;
initiating plant growth in the bag;
setting the bag into a basin;
putting water into the bag from the top thereof;
permitting the water to flow out of the bag and into the basin; and
collecting water in the basin to a predefined level on the bag.

19. A method for growing a plant comprising:
(a) placing a medium that supports root growth of the plant into a bag made of a mesh fabric through which roots of the plant can grow;
(b) initiating plant growth in the bag;
(c) growing the plant; and
(d) placing a medium that supports root growth of the plant into a bag larger than the preceding one, the bag being made of a mesh fabric through which roots of the plant can grow; and
(e) placing the preceding bag into the larger bag.

20. The method of claim 19 further comprising repeating steps (c) through (e) at least one time.
